(19) United States
(12) Patent Application Publication
(10) Pub. No.: US 2005/0100709 A1
(43) Pub. Date: May 12, 2005

(54) Retroreflective elements comprising a bonded resin core and pavement markings

(75) Inventors: Terrance L. Bescup, River Falls, WI (US); Stephen L. Lieder, Wyoming, MN (US); Joseph D. Engebretson, St. Croix Falls, WI (US); Maureen C. Nelson, West St. Paul, MN (US); Thomas P. Hedblom, Eagan, MN (US); Maiken Givot, St. Paul, MN (US); Mark D. Purgett, Oakdale, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/982,013

(22) Filed: Nov. 4, 2004

Related U.S. Application Data
(60) Provisional application No. 60/517,793, filed on Nov. 6, 2003.

(51) Int. Cl. B32B 1/00

(52) U.S. Cl. 428/143

(57) ABSTRACT

The invention relates to retroreflective elements comprising a bonded resin core and microspheres at least partially embedded into the surface of the core.

### RELATED APPLICATIONS

This application claims priority to U.S. Patent Application Ser. No. 60/517793, filed Nov. 6, 2003

### FIELD OF THE INVENTION

The invention relates to retroreflective elements comprising a bonded resin core and a plurality of microcrystalline microspheres at least partially embedded into the surface of the core.

### BACKGROUND OF THE INVENTION

The use of pavement markings (e.g. paints, tapes, and individually mounted articles) to guide and direct motorists traveling along a roadway is well known. During the daytime the markings may be sufficiently visible under ambient light to effectively signal and guide a motorist. At night, however, especially when the primary source of illumination is the motorist's vehicle headlights, the markings are generally insufficient to adequately guide a motorist because the light from the headlight hits the pavement and marking at a very low angle of incidence and is largely reflected away from the motorist. For this reason, improved pavement markings with retroreflective properties have been employed.

Retroreflection describes the mechanism where light incident on a surface is reflected so that much of the incident beam is directed back towards its source. The most common retroreflective pavement markings, such as lane lines on roadways, are typically made by dropping transparent glass or ceramic microspheres onto a freshly painted line such that the microspheres become partially embedded therein. The transparent microspheres each act as a spherical lens and thus, the incident light passes through the microspheres to the base paint or sheet striking pigment particles therein. The pigment particles scatter the light redirecting a portion of the light back into the microsphere such that a portion is then redirected back towards the light source.

Vertical surfaces tend to provide better orientation for retroreflection. Therefore, numerous approaches have been made to incorporate vertical surfaces in pavement markings, typically by providing protrusions in the marking surface. Vertical surfaces can prevent the build-up of a layer of water over the retroreflective surface during rainy weather that may otherwise interfere with the retroreflection mechanism of microspheres exposed on the surface. In addition to providing the desired retroreflective properties, pavement markings are often required to withstand road traffic and weathering over an extended duration of time.

For these reasons, retroreflective elements have been developed wherein optical elements are bonded to a core, in order to increase the number of optical elements that are provided in a vertical orientation.

For example, U.S. Pat. Nos. 5,772,265 and 5,942,280 describe all-ceramic retroreflective elements that may be used in pavement markings comprising an opacified ceramic core and ceramic optical elements partially embedded into the core (abstract). Representative retroreflective elements of this nature are commercially available from 3M Company, St. Paul, Minn. under the trade designations “3M Stamark™ Liquid Pavement Markings Elements 1270” (white) and “3M Stamark™ Liquid Pavement Markings Elements 1271” (yellow). Such retroreflective elements have been employed in pavement markings.

Although such retroreflective elements provide suitable retroreflective properties in combination with suitable durability, industry would find advantage in alternative retroreflective elements, particularly those that may be manufactured at a reduced cost.

### SUMMARY OF THE INVENTION

The invention relates to retroreflective elements and retroreflective articles including pavement markings. The invention also relates to methods of making retroreflective articles such as pavement markings and tapes as well surfaces (e.g. pavement) comprising such markings and tapes.

The retroreflective elements preferably have a coefficient of retroreflection of at least 10 candelas/lux/m² and more preferably of at least 20 candelas/lux/m².

The pavement marking preferably exhibits an initial R_{L} according to ASTM E 1710-97 of at least 2000 millicandelas/m²/lux. Further, the pavement marking exhibits an R_{L} of at least 400 millicandelas/m²/lux after 22 weeks of accelerated wear testing.

The retroreflective elements comprise a bonded resin core and a plurality of microcrystalline microspheres at least partially embedded in the core. The retroreflective article, such as the pavement marking or tape, comprise these retroreflective elements partially embedded in a binder.

The microcrystalline microspheres may be non-vitreous or comprise a glass-ceramic material. The bonded resin core preferably comprises at least one light scattering material including diffusely reflecting pigments, specularly reflecting pigment and combination thereof. The retroreflective elements may comprise a combination of microcrystalline microspheres having different refractive indexes. The retroreflective elements preferably range in size from about 2 mm to about 3 mm. The elements may include a single inorganic particle within the bonded resin core such as sand, roofing granules, or skid particles. The particle preferably ranges in size from about 0.1 mm to about 3 mm. The particle, the microspheres as well as the retroreflective elements are each preferably surface treated with an (e.g. organosilane) adhesion-promoting agent. In the preparation of the retroreflective elements, the microspheres are preferably surface treated with at least one fluorochemical floatation agent. In the preparation of a pavement marking or other retroreflective article, the retroreflective elements are preferably bonded with such floatation agent as well. The bonded resin prior to curing preferably has a Brookfield viscosity at 77° F. ranging from about 1000 cps to about 10,000 cps. Further, the bonded resin is preferably substantially free of solvent.

In one preferred embodiment, the pavement marking employs retroreflective elements comprising transparent microcrystalline microspheres in combination with the bonded resin core comprising at least 30 wt-% pearlescent pigment thereby providing a pavement marking having a high initial brightness (e.g. at least about 1000 millicandelas/lux/m²).

In another embodiment, the invention relates to a method for making a pavement marking comprising applying a binder composition to a pavement surface and partially embedding the retroreflective elements in the binder. The binder may comprise a traffic marking paint, a thermoplastic binder, or a (e.g. two-part) reactive binder.

### DETAILED DESCRIPTION OF THE INVENTION

The retroreflective elements of the invention generally comprise a bonded resin core and a plurality of microcrystalline microspheres partially embedded into the surface of the core.

As used herein, “bonded resin core” refers to a crosslinked (e.g. cured) resin. The bonded resin core is derived from a precursor composition that comprises monomeric, oligomeric, and/or polymeric components, as well as mixtures thereof, that crosslink upon exposure to heat (e.g. thermoset), actinic radiation (e.g. ultraviolet light, electron beam) or other chemical reaction (e.g. catalyst).

Microcrystalline microspheres (also referred to herein as “beads”) comprise a crystalline phase or combination of an amorphous phase and a crystalline phase. In contrast, glass refers to an inorganic material that is predominantly amorphous (a material having no long range order in its atomic structure evidenced by the lack of a characteristic x-ray diffraction pattern). The microcrystalline microsphere may be non-vitreous, such as described in U.S. Pat. No. 4,564,556 (Lange) or the microspheres may comprise a glass-ceramic material, such as described in U.S. Pat. No. 6,461,988, also incorporated herein by reference.

The microspheres are preferably ceramic (e.g. glass-ceramic). As used herein, “ceramic” refers to an inorganic material that is predominantly crystalline and typically having a microcrystalline structure (a material having a patterned atomic structure sufficient to produce a characteristic x-ray diffraction pattern). Ceramic microspheres preferably comprise zirconia, alumina, silica, titania, and mixtures thereof. These microspheres comprise at least one crystalline phase containing at least one metal oxide. These microspheres also may have an amorphous phase such as silica. The microspheres are resistant to scratching and chipping, are relatively hard (above 700 Knoop hardness), and are made to have a relatively high index of refraction.

For core dimensions, having a diameter ranging from about 0.2 to about 10 millimeters, the microspheres typically range in size from about 30 to about 300 micrometers in diameter.

The bonded resin core typically further comprises at least one light scattering material such that the core is diffusely reflecting and preferably specularly reflecting. By combining such reflective bonded resin core with transparent microcrystalline microspheres, retroreflective elements with high initial brightness can be obtained. The coefficient of retroreflection of the retroreflective elements, R_{A}, is typically at least about 10 cd/lux/m² (e.g. at least 15 cd/lux/m², at least 20 cd/lux/m², at least 25 cd/lux/m² and greater) according to the test method described in the forthcoming examples.

Surprisingly, the retroreflective elements of the present invention exhibit at least comparable and often better retroreflective properties in comparison to retroreflective elements having a ceramic core. “The same retroreflective elements” refers to retroreflective elements comprising the same microspheres with the primary difference being that the core comprises a different composition. The bonded resin core retroreflective elements, however, can be manufactured by less costly processes than retroreflective elements having a ceramic core.

The initial coefficient of retroreflected luminance (R_{L}) of the pavement markings of the invention is at least 1000 candelas/lux/m² and thus at least about the same initial R_{L} as the same retroreflective element having an opacified ceramic core. In preferred embodiments, the pavement markings of the invention exhibit improved retroreflective properties. For such embodiments, the initial coefficient of retroreflected luminance, R_{L}, may be at least 1500 candelas/lux/m², at least 1800 candelas/lux/m², at least 2000 candelas/lux/m², at least about 2200 candelas/lux/m², at least 2500 candelas/lux/m², or greater.

The durability of a pavements marking is typically determined by measuring coefficient of retroreflected luminance (R_{L}) of the pavement marking according to ASTM E 1710-97 after various duration of time. Accelerated testing can be performed by applying the pavement markings in the direction of traffic in the wheel path. As is commonly known, the majority of pavement lane markings are applied parallel to the direction of the traffic as either center lines or edge lines. Typically, 10 days of the accelerated wear testing in a wheel path corresponds to about 100 days of edge line usage. The pavement markings employing bonded resin core retroreflective elements typically have an R_{L} of at least 400 millicandelas/lux/m² after 22 weeks of accelerated wear testing and even longer durations of time.

Classes of bonded resins suitable for use in the invention generally include epoxies, polyurethanes, alkyds, acrylics, polyesters, phenolics and the like. Various epoxies, polyurethane, and polyesters are generally described is U.S. Pat. Nos. 3,254,563; 3,418,896 and 3,272,827; incorporated herein by reference. The bonded resin composition may have increased resiliency. It is surmised that a more resilient core will temporarily deform upon impact with an automobile tire for example, preventing abrasion of the microspheres from the exposed surface. Alternatively, or in addition thereto, the bonded resin may be relatively tougher meaning that the total energy to break according to ASTM D82 is substantially higher than bonded resin core materials previously employed. Typically, the total energy is higher is view of the bonded resin exhibiting a higher elastic modulus.

Preferred bonded resins include certain epoxy resins such as available from 3M Company, St. Paul, Minn. under the trade designation “3M Scotchcast™ Electrical Resin Product No. 5” and certain polyurethanes including those derived from the reaction product of a trifunctional polyol, such as commercially available from Dow Chemical, Danbury, Conn. under the trade designation “Tone 0301”, with an adduct of hexamethylene diisocyanate (HDI), such as commercially available from Bayer Corp., Pittsburg, Pa. under the trade designation “Desmodur N-100” at a weight ratio of about 1:2.

Other polyester polyols that may be employed at appropriate equivalent weights include “Tone 0305”, “Tone 0310” and “Tone 0210”. Further, other polyisocyanates include “Desmodur N-3200”, “Desmodur N-3300”, “Desmodur N-3400”, “Desmodur N-3600”, as well as “Desmodur BL 3175A”, a blocked polyisocyanate based on HDI, that is surmised to contribute substantially improved “pot life” as a result of minimal changes in viscosity of the polyol/polyisocyanate mixture.

The bonded resin core may optionally comprise other ingredients such as fillers (e.g. glass beads) and solvents(s). Preferably however, the resin composition, prior to curing, has a suitable viscosity, such that solvent diluents are not needed. It has been found that the Brookfield viscosity (test method DTM 300) of the bonded resin composition at 72° F., prior to curing and prior to addition of light scattering material as will subsequently be described, is typically at least about 1000 cps. In order to disperse relatively high concentrations of light scattering material, however, the Brookfield viscosity of the bonded resin composition at 72° F. is typically less than 10,000 cps (e.g. less than 9,000 cps; 8,000 cps, 7,000 cps; 6,000 cps; 5,000 cps). For example, the bonded resin may have a Brookfield viscosity at 72° F. of about 1500 cps to 2500 cps.

Although the retroreflective elements may be prepared from a non-diffusely reflecting bonded resin core in combination with specularly reflecting microspheres for example vapor coating the microspheres with aluminum, this approach results in less durable retroreflective elements due to the use of exposed metal subject the degradation. Less durable retroreflective elements would also result by incorporating metals (e.g. aluminum) into the core. In preferred embodiments, the retroreflective elements comprise at least one non-metallic light scattering material dispersed within the bonded resin core. This reflecting core is combined with transparent microspheres that are substantially free of metals (e.g. aluminum coatings).

Diffuse reflection is caused by light scattering within the material. The degree of light scattering is generally due to a difference in the refractive index of the scattering phase in comparison to the base composition of the core phase. An increase in light scattering is observed typically when the difference in refractive index is greater than about 0.1. Typically, the refractive index difference is greater than about 0.4. (e.g. greater than 0.5, 0.6, 0.7 and 0.8).

For the bonded resin core materials employed in the present invention, light scattering is provided by combining the base bonded resin core material with at least one diffusely reflecting particles and/or at least one specularly reflecting particles. Examples of useful diffuse pigments include, but are not limited to, titanium dioxide, zinc oxide, zinc sulfide, lithophone, zirconium silicate, zirconium oxide, natural and synthetic barium sulfates, and combinations thereof. A preferred specular pigment is a pearlescent pigment. Pearlescent pigments contain reflective non-metallic minerals such mica coated with a thin layer of titanium dioxide or iron oxide. Pearlescent pigments are commercially available from EM Industries, Inc., Hawthorne, N.Y. under the trade designations “Afflair 9103”, “Afflair 9119”, “Mearlin Fine Pearl #139V” and “Bright Silver #139Z”.

The diffusely reflective pigments are typically employed at a concentration of at least 30 wt-%. Specularly reflecting pigments are preferred and typically employed in an amount of at least 10 wt-%. In preferred embodiments, the bonded resin core comprises at least 20 wt-% and more preferably at least 30 wt-% specularly reflecting pigments.

Other pigments may be added to the core material to produce a colored retroreflective element. In particular yellow, is a desirable color for pavement markings. In order to maximize the reflectance of the element, particularly in combination with transparent microspheres, it is preferred to maximize the concentration of pigment provided that coating viscosity, and cured binder physical properties are not compromised. Typically, the maximum total amount of light scattering material is about 40 to 45 wt-%.

The reflective properties of the bonded core material comprising one or more light scattering materials can conveniently be characterized as described in ANSI Standard PH2.17-1985. The value measured is the reflectance factor that compares the diffuse reflection from a sample, at specific angles, to that from a standard calibrated to a perfect diffuse reflecting material. For retroreflective elements that employ a diffusely reflecting core, the reflectance factor of the core is typically at least 75% at a thickness of 500 micrometers for retroreflective elements with adequate brightness for highway markings. More typically, the core has a reflectance factor of at least 85% at a thickness of 500 micrometers.

The retroreflective element may comprise microspheres having the same, or approximately the same refractive index. Alternatively, the retroreflective element may comprise microspheres having two or more refractive indices. Likewise, the pavement marking may comprise retroreflective elements having the same refractive index or retroreflective elements having two or more refractive indices. Further yet, the pavement marking may comprise a retroreflective element in accordance with the invention in combination with one or more microspheres having the same or two or more refractive indices. Typically, microspheres having a higher refractive index perform better when wet and microspheres having a lower refractive index perform better when dry. When a blend of microspheres having different refractive indices is used, the ratio of the higher refractive index microspheres to the lower refractive index microspheres is preferably about 1.4 to about 1.05, and more preferably from about 1.3 to about 1.08.

Typically, for optimal retroreflective effect, the microspheres have a refractive index ranging from about 1.5 to about 2.0 for optimal dry retroreflectivity, preferably ranging from about 1.5 to about 1.9. For optimal wet retroreflectivity, the microspheres have a refractive index ranging from about 1.7 to about 2.6, preferably ranging from about 1.9 to 2.6, and more preferably ranging from about 2.1 to about 2.3.

The microspheres can be colored to retroreflect a variety of colors. Further, the microspheres can be color matched to the marking paints in which they are embedded. Techniques to prepare colored ceramic microspheres that can be used herein are described in U.S. Pat. No. 4,564,556. Colorants such as ferric nitrate (for red or orange) may be added in the amount of about 1 to about 5 weight percent of the total metal oxide present. Color may also be imparted by the interaction of two colorless compounds under certain processing conditions (e.g., TiO₂ and ZrO₂ may interact to produce a yellow color).

Other optical elements such as granules, flakes (e.g. aluminum flakes) and fibers may be employed in addition to the microcrystalline microspheres, provided that such optical elements are compatible with the size, shape, and geometry of the core.

The retroreflective elements may further comprise a particle within the bonded resin core. The particle is typically comprised of an inorganic material, such as sand, roofing granules and skid particles. In such embodiments, the particle is typically a single particle ranging in size from about 0.1 mm to about 10 mm. Preferably, the particle size is greater than 300 microns and less than 2000 microns.

Such retroreflective elements can be prepared by providing a plurality of particles (e.g. inorganic), coating the particles with a bonded resin core precursor composition (i.e. resin composition prior to crosslinking), embedding a plurality of microspheres in the bonded resin core precursor; and curing said bonded resin core precursor. A suitable method is generally described in U.S. Pat. No. 3,175,935 (Vanstrum). It is preferred to break up clusters of agglomerated particles prior to coating the particles with the bonded resin core precursor composition and prior to contacting the coated particles with the microspheres.

Alternatively, the retroreflective elements can be prepared by providing discrete portions such as droplets of a bonded resin core precursor composition; embedding a plurality of microspheres in the bonded resin core precursor; and curing said bonded resin core precursor. Such a method is generally described in U.S. Pat. No. 3,254,563 (De Vries et al.). The droplets are typically injected onto a static bed. The static bed typically has a sufficient depth of microspheres to prevent the droplets from contacting the underlying belt. A slight excess of microspheres are then sprinkled on top to cover the exposed surface of the droplets. It has been discovered that the presence of surface treatments (i.e. adhesion promoting agent and/or floatation aid) on the microspheres surprisingly interacts with the droplet surface to maintain the shape of the droplet.

Preferred methods of making the bonded resin core microspheres include combining the core particles with the microspheres by a device comprising at least one rotating mixing member such as a disc, an extruder, co-rotating or counter-rotating blades, and grinding plates as described in further detail in U.S. patent application Ser. No. 10/761874, filed Jan. 21, 2004; incorporated herein by reference.

In such methods, the liquid bonded resin precursor is typically partially cured prior to embedding the microspheres. Such partial curing aids the bonded resin in maintaining its shape as well as allows for sufficient initial bonding of the microspheres to the core, prior to completion of curing. For embodiments wherein partial curing is not controlled or wherein partial curing alone does not result in the proper consistency to form a stable droplet, the bonded resin precursor can be thickened with fillers, such as glass beads for example. Further, bonded resin precursor compositions that are too viscous can be diluted with solvent to improve the initial bonding and bead embedment. Bonded resins that cure too slowly often result in a deformed (i.e. less spherical) droplet or a multi-layer core construction; whereas bonded resins that cure too fast can exhibit droplet “tails”.

Regardless of the method, the microspheres (e.g. beads) are preferably treated with at least one adhesion promoting agent and/or at least one floatation agent. Further, for embodiments wherein the bonded resin core further comprises a particulate core within the bonded resin core, the particle core is preferably treated with at least one adhesion promoting agent.

Organosilane adhesion promoting agents, also referred to as coupling agents, typically comprise at least one functional group that interacts with the bonded resin and a second functional group that interacts with the microspheres and or particulate core. In general, the adhesion promoting agent is chosen based on the chemistry of the bonded resin. For example, vinyl terminated adhesion promoting agents are preferred for polyester-based bonded resins, such as polyester resins formed from addition reactions. In the case of epoxy bonded resins, amine terminated adhesion promoting agents are preferred. The preferred adhesion promoting agents for polyurethanes, particularly for microcrystalline microspheres (e.g. glass-ceramic beads) and inorganic core materials (e.g. sand, skid particles) are amine-terminated silanes such as 3-aminopropyltriethoxysilane, commercially available from GE Silicones 3500 under the trade designation “Silquest A-1100”.

Suitable floatation agents include various fluorochemicals such as described in U.S. Pat. No. 3,222,204, U.S. patent application attorney docket no. 56059US009, filed Oct. 24, 2001 that claims priority to application Ser. No. 09/698434 filed Oct. 27, 2000; and U.S. patent application Ser. No. 09/961669 filed Sep. 24, 2001; each of which are incorporated herein by reference. A preferred floatation agent includes polyfluoropolyether based surface treatment such as poly(hexafluoropropylene oxide) having a carboxylic acid group located on one chain terminus, commercially available from Du Pont, Wilmington, Del. under the trade designation “Krytox”. “Krytox” 157 FS is available in three relatively broad molecular weight ranges, 2500 g/mole (FSL), 3500-4000 g/mole (FSM) and 7000-7500 g/mole (FSH), respectively for the low, medium and high molecular weights. The low and medium molecular weight grades are preferred for aqueous delivery of the surface treatment. Other preferred floatation agents are described in WO 01/30873 (e.g. Example 16).

The retroreflective elements may have virtually any size and shape, provided that the coefficient of retroreflection (R_{A}), is at least about 3 cd/lux/m² according to Procedure B of ASTM Standard E809-94a using an entrance angle of −4.0 degrees and an observation angle of 0.2 degrees. The preferred size of the retroreflective elements, particularly for pavement marking uses, ranges from about 0.2 mm to about 10 mm and is more preferably about 0.5 mm to about 3 mm. Further, substantially spherical elements are more preferred. For the majority of pavement marking uses, R_{A} is typically at least about 5 cd/lux/m² (e.g. at least 6 cd/lux/m², at least 7 cd/lux/m², at least 8 cd/lux/m² and greater).

The microspheres are typically embedded to a depth sufficient to hold the microspheres in the core during processing and use. Embedment of at least 20% of the diameter of the microspheres typically will effectively hold the optical element into the core. By 20% embedded, it is meant that about 80% of the total number of microspheres are embedded within the core surface such that about 20% of each bead is sunk into the core and about 80% is exposed on the core surface. If the microspheres are embedded greater than about 80%, the retroreflective properties tend to be substantially diminished. In order to obtain a balance of bonding between the microspheres and the core in combination with suitable retroreflectivity, typically more than about 90% of the total number of beads are embedded to a depth of about 40% to about 60%.

The retroreflective elements of the invention can be employed for producing a variety of retroreflective products or articles such as retroreflective sheeting and in particular pavement markings. Such products share the common feature of comprising a binder layer and a multitude of retroreflective elements embedded at least partially into the binder surface such that at least a portion of the retroreflective elements are exposed on the surface. In the retroreflective article of the invention, at least a portion of the retroreflective elements will comprise the retroreflective elements of the invention and thus, the inventive elements may be used in combination with other retroreflective elements as well as with other microspheres (e.g. transparent beads).

Various known binder materials may be employed including various one and two-part curable binders, as well as thermoplastic binders wherein the binder attains a liquid state via heating until molten. Common binder materials include polyacrylates, methacrylates, polyolefins, polyurethanes, polyepoxide resins, phenolic resins, and polyesters. A preferred binder includes a two-part composition having an amine component including one or more aspartic ester amines and optionally one or more amine-functional coreactants, an isocyanate component including one or more polyisocyanates, and material selected from the group of fillers, extenders, pigments and combinations thereof, described in U.S. Pat. No. 6,166,106, incorporated herein by reference. For reflective paints the binder typically comprises reflective pigment. For retroreflective sheeting, however, the binder may be transparent. In the case of sheeting, the binders are applied to a reflective base or may be applied to a release-coated support, from which after solidification of the binder, the beaded film is stripped and may subsequently be applied to a reflective base or be given a reflective coating or plating.

Prior to combining the elements with the liner the retroreflective elements are typically coated with one or more surface treatments that alter the binder wetting properties and/or improve the adhesion of the retroreflective elements in the liquid binder. Preferred surface treatments include those previously described for coating the microspheres and/or particulate core. The retroreflective elements are typically embedded in the binder to about 20-40%, and preferably to about 30% of their diameters such that the retroreflective elements are adequately exposed.

The retroreflective elements of the invention are particularly useful in pavement marking materials. The retroreflective elements of the present invention can be dropped or cascaded onto binders such as wet paint, thermoset materials, or hot thermoplastic materials (e.g., U.S. Pat. Nos. 3,849,351, 3,891,451, 3,935,158, 2,043,414, 2,440,584, and 4,203,878). In these applications, the paint or thermoplastic material forms a matrix that serves to hold the retroreflective elements in a partially embedded and partially protruding orientation. The matrix can also be formed from durable two component systems such as epoxies or polyurethanes, or from thermoplastic polyurethanes, alkyds, acrylics, polyesters, and the like.

Typically, the retroreflective elements of the present invention are applied to a roadway or other surface through the use of conventional delineation equipment. The retroreflective elements are dropped from a random position or a prescribed pattern if desired onto the surface, and each retroreflective element comes to rest with one of its faces disposed in a downward direction such that it is embedded and adhered to the paint, thermoplastic material, etc. If different sizes of retroreflective elements are used, they are typically evenly distributed on the surface. When the paint or other film-forming material is fully cured, the retroreflective elements are firmly held in position to provide an extremely effective retroreflective marker.

The retroreflective elements of the present invention can also be used on preformed tapes (i.e. pavement marking sheets) in which the binder and retroreflective elements are generally provided on the viewing surface of the tape. On the opposing surface a backing such as acrylonitrile-butadiene polymer, polyurethane, or neoprene rubber is provided. The opposing surface of the pavement marking tape also generally comprises an adhesive (e.g., pressure sensitive, heat or solvent activated, or contact adhesive) beneath the backing. During use the adhesive is contacted to the target substrate, typically pavement.

Pavement markings often further comprise skid-resistant particles to reduce slipping by pedestrians, bicycles, and motor vehicles. The skid-resistant particles can be, for example, ceramics such as quartz, aluminum oxide, silicon carbide or other abrasive media.

Objects and advantages of the invention are further illustrated by the following examples, but the particular materials and amounts thereof recited in the examples, as well as other conditions and details, should not be construed to unduly limit the invention. All percentages and ratios herein are by weight unless otherwise specified.

### EXAMPLES

### Test Methods

Retroreflection of Retroreflective Elements—Coefficient of Retroreflection (R_{A})

Brightness was measured as the coefficient of retroreflection (R_{A}) by placing enough retroreflective elements in the bottom of a dish that was at least 2.86 cm in diameter such that no part of the bottom of the dish was visible. Then Procedure B of ASTM Standard E809-94a was followed, using an entrance angle of −4.0 degrees and an observation angle of 0.2 degrees. The photometer used for the measurements is described in U.S. Defensive Publication No. T987,003.

Retroreflection of Pavement Marking—Retroreflective Luminance (R_{L})

The coefficient of retroreflected luminance (R_{L}) of the pavement marking can be tested according to ASTM E 1710-97.

Retroreflection of Pavement Marking Coated Panels

This method utilizes a RS-50 Source A lamp with regulated power supply light source and a photometric camera commercially available from Radiant Imaging, Duvall, Wash., under the trade designation “Prometric CCD Light and Color Measurement System Model 9920-1” equipped with a 70-300 mm telephoto lens, computer and associated software (version 7.2.13 or later). The light source and camera are each provided on separate carts having vertical and horizontal positioning capability, in order to simulate standard pavement marking measurement geometries (e.g. 20 m, 30 m, 50 m, or 80 m) for pavement marking coated panels. The panels may range in width from 1 inch (2.5 cm) to 6 inches (15 cm) and range in length from 60 inches (152 cm) to 6 inches (15 cm).

The positioning of the light source and camera are adjusted for the specific geometry of interest. The lamp is turned on and allowed to stabilize for a minimum of 20 minutes prior to making measurements. The camera is calibrated in accordance with the manufacture's instructions and allowed to cool to −10 C. before making any quantitative measurements.

A pavement marking reference panel is placed on a table. The f-stop, zoom, exposure time and focus of the camera are manually adjusted such that a clear image can be recorded. A black velvet cloth is placed on a table such that the cloth is laying flat without wrinkles. An illuminance target is placed on top of the black velvet cloth at the center point of each sample position and just in front of the sample holder locator pins with the target face perpendicular to the light source. An image is recorded with the camera of the illuminance target at the center point of each sample position. A test sample is placed in a sample holder on the sample table. The camera records the image of the test sample. From the images recorded, the luminance of the test sample at the center point of the test sample is determined.

The analysis tool of the software of the camera is employed to measure the luminance of the test sample and the illuminance target using the same virtual detector size for both.

The Coefficient of Retroreflection (R_{L}) of the test sample is calculated as follows:

$$\begin{matrix}Test Sample \\ {R}_{L} ( mcd / {m}^{2} / lux )\end{matrix} = \frac{( Test Sample cd / {m}^{2} ) \times ( 1000 mcd / cd )}{( Illuminance Target cd / {m}^{2} \times p lux / ( cd / {m}^{2} ) )}$$

where the value of p can be approximated as 3.1416.

In addition to the coefficient of retroreflected luminance (R_{L}) of the pavement marking coated panels being measured when the panels were dry, as just described, this same procedure was repeated using two different wet condition. “Wet Continuous” measurements were taken by canting the sample to 3 degrees about the sample width simulating the crown of a typical roadway. Water sprinkled onto the sample at a rate of 5 inches (12.7 cm) of water per hour for a minimum of 1 minute prior to taking readings. For “Wet Recovery”, the procedure for wet continuous is repeated. The flow of water is shut off and the sample allowed to recover for 45 seconds and then taking a measurement.

The microcrystalline microspheres employed in the Examples 1-4, Comparative Element A were glass ceramic beads having a starting oxide material composition by weight of 30.9% TiO₂, 15.8% SiO₂, 14.5% ZrO₂, 1.7% MgO, 25.4% Al₂O₃ and 11.7% CaO. The beads were prepared according to U.S. Pat. No. 6,245,700 to provide beads that had a nominal refractive index of 1.9. The beads were surface treated first with “Silquest A-1100” adhesion promoting agent by first diluting approximately 8 wt-% of “Silquest A-1100” with water such that the amount was sufficient to coat the beads and provide 600 ppm on the dried beads. The beads were then treated with “Krytox 157 FSL” floatation promoting agent in the same manner, to provide 100 ppm of such treatment. Each surface treatment was applied by placing the beads in a stainless steel bowl and drizzling the diluted solution of the surface treatment over the beads while continuously mixing to provide wetting of each bead. After each treatment, the microspheres were placed in an aluminum drying tray at a thickness of about 1.9 cm and dried in a 66° C. oven for approximately 30 minutes.

### Example 1

### Retroreflective Elements

A polyurethane precursor composition was prepared by mixing the following ingredients:

Wt-%

| | |
|---|---|
| 15.3% | Polyester polyol, available from Dow Chemical, Danbury, CT |
| | under the trade designation “TONE 0301” |
| | (Brookfield viscosity = 2400 at 72° F.) |
| 31% | Aliphatic polyisocyanate, available from Bayer Corp., |
| | Pittsburgh, PA under the trade designation |
| | “DESMODUR N-100” (Brookfield viscosity = 7500 at 72° F.) |
| 37% | pearlescent pigment, commercially available from EM Industries |
| | Corporation under the trade designation |
| | “AFFLAIR 9119” |
| 5.9% | methyl ethyl ketone solvent |
| 5.9% | acetone solvent |
| 4.9% | additives (dispersants, modifiers) |

The polyurethane precursor solution was added to a 600 ml beaker containing surface treated sand ranging in particle size from 1000 to 500 microns size, commercially available from Unimin Corp., Portage Mich., under the trade designation “#4095”, distributed by Sterling Supply, Minneapolis, Minn. The sand was surface treated with 600 ppm “Silquest A1100” (without “Krytox 157 FSL”) in the same manner as previously described for surface treating the beads. The sand were stirred as the polyurethane was added. A ratio of 10 parts by weight particles to 1 parts by weight polyurethane sufficiently coated the particles. The polyurethane coated sand was then slowly added to a 600 ml beaker having about 1 inch (2.5 cm) of glass-ceramic beads that were surface treated as previously described. The volume ratio of coated sand particles to glass-ceramic beads was about 1:10. The beads were stirred during addition of the polyurethane coated particles until the polyurethane coated particles were completely covered with the beads. The resulting retroreflective elements were then cured 30 minutes at 250° F. (121° C.). Brightness of the elements was measured as previously described. A R_{A} value of 31 candelas/lux/m² was obtained.

### Example 2

### Retroreflective Elements

A polyurethane precursor composition was prepared by mixing the following ingredients:

Wt-%

| | |
|---|---|
| 22.8% | Polyester polyol, available from Dow Chemical, Danbury, CT |
| | under the trade designation “TONE 0301” |
| 47.9% | Aliphatic polyisocyanate, available from Bayer Corp., |
| | Pittsburgh, PA under the trade designation “DESMODUR |
| | N-100” |
| 24.6% | Rutile titanium dioxide pigment, available from DuPont, |
| | New Johnsonville, TN under the trade designation “TIPURE |
| | R-960” |
| 4.7% | methyl ethyl ketone solvent |

Retroreflective elements were prepared with the composition by delivering droplets of the precursor from a 5 cc syringe. The syringe was equipped with a 25 gauge needle forming droplets that were approximately 1-2 mm in diameter. The droplets were allowed to descend a distance of about 2-8 inches (5-20 cm) onto a bed of the surface treated beads. Additional surface treated beads were sprinkled on top of the droplets such that the droplets were completely coated with the beads. The resulting retroreflective elements were cured 30 minutes at 250° F. (121° C.). The brightness was measured as previously described and a value of 7.9 candellas/lux/m² was obtained.

### Example 3

### Retroreflective Elements

Retroreflective elements were prepared in the same manner as Example 2 with the exception that the precursor composition of Example 1 was used. The resulting elements were allowed to cure 30 minutes at 250° F. (121° C.). The brightness was measured as previously described and a value of 17.5 candelas/lux/m² was obtained

### Example 4

### Retroreflective Elements

Retroreflective elements were prepared in the same manner as Example 2 with the exceptions that the precursor composition contained 25 wt-% of “Afflair 9119” pearlescent pigment and 75 wt-% of “3M Scotchcast Electrical Resin Product No. 5” (parts A & B) was used instead of the pearlescent pigmented polyurethane precursor composition and the elements were cured for 16 hours at 90° C. The brightness was measured as previously described and a value of 7 candelas/lux/m² was obtained.

### Example 5

### Retroreflective Elements

Retroreflective elements were prepared in the same manner as Example 1 with the exception that the bonded resin core composition contained 25 wt-% of “Afflair 9119” pearlescent pigment and 75 weight percent “3M Scotchcast Electrical Resin Product No. 5 parts A & B” was used instead of the pearlescent pigmented polyurethane precursor composition and the elements were cured for 16 hours at 90° C. The brightness was measured as previously described and a value of 21 candelas/lux/m² was obtained.

### Example 6

### Retroreflective Elements

A polyurethane precursor composition may be prepared by mixing the following ingredients:

Wt-%

| | |
|---|---|
| 20.8% | Polyester polyol, available from Dow Chemical, Danbury, CT |
| | under the trade designation “TONE 0301” |
| 39.2% | Aliphatic polyisocyanate, available from Bayer Corp., |
| | Pittsburgh, PA under the trade designation “DESMODUR |
| | N-3200” (Brookfield viscosity = 1800 cps at 72° F.) |
| 40% | pearlescent pigment, commercially available from EM Industries |
| | Corporation under the trade designation “AFFLAIR 9119” |

This composition advantageously comprises a relatively high concentration of pigment, yet is free of solvents. This composition is expected to have at least comparable performance to Example 1. Retroreflective elements may be prepared using either the method of Example 1 or the method of Example 2.

### Example 7

### Retroreflective Elements

The retroreflective elements were prepared in the same manner as Example 1 except that 40 g of coated sand and 1200 g of the glass ceramic beads were mixed in a 1000 ml polyethylene beaker. A hand kitchen mixer obtained from Hamilton Beach under the trade designation “Portfolio” equipped with dual four bladed beaters each with a collar, was inserted into the beaker containing the beads and the coated sand. Each beater had a radius of 1.75 inches (4.4 cm), the width of each of the flour blades was ¼ inch (0.63 cm) and had a length of 3.25 inches (8.3 cm). The glass ceramic beads and the coated sand were mixed at maximum speed. The mixer and 1000 ml beaker were rotated so that the coated and clustered sand was drawn through the co-rotating beaters in the presence of the excess beads. This was continued until most or all of the coated sand was in the form of discrete particles, resulting in a sand core coated with a bonded resin core precursor and covered with the glass ceramic beads. In order to solidify the bonded resin precursor coating, the coated sand particles having surfaces substantially covered with embedded beads were cured for 30 minutes in an 80° C. oven.

### Example 8

### Retroreflective Elements

The retroreflective elements were prepared in the same manner as Example 1 except that a disc coater, as described in U.S. patent application Ser. No. 10/762032 filed Jan. 21, 2004 was employed to embed the glass ceramic beads in the bonded resin core, as described in Example 6 of U.S. patent application Ser. No. 10/761874, filed Jan. 21, 2004.

### Comparative Element A

Comparative Element A is a retroreflective element having an opacified glass core and the same glass ceramic beads as used in the inventive examples partially embedded in the core. Such comparative retroreflective elements are commercially available from 3M under the trade designations “3M Stamark Liquid Pavement Markings Elements 1270” (white) and “3M Stamark Liquid Pavement Markings Elements 1271” (yellow). The brightness was measured as previously described and a value of ˜9-11 candellas/lux/m² was obtained.

### Exemplary Pavement Markings

Pavement markings were prepared from the bonded resin core retroreflective elements of Examples 1, 3, 5, 7 and 8 as well as a comparative ceramic core retroreflective element.

Each of the bonded resin core retroreflective elements of Example 1, 3, 5, 7, and 8 were surface treated in the same manner as the glass-ceramic beads with treatment levels of 600 ppm Silquest A 1100 and 25 ppm Krytox 157 FSL or FC4431, as previously described. FC4431 was obtained from Specialty Chemicals Division of 3M Company.

The pavement markings were applied in the wheel path section of a test roadway in the following manner. A clean, dry section of the roadway was selected and a 25 mil to 30 mil wet thickness line of “3M Stamark™ Liquid Pavement Marking 1500 White Part A and 1530 Crosslinker Part B” 4 inches (10 cm) wide was coated on the roadway using a wet film applicator, 8-Path Wet Film Applicator model #25, obtained from Paul N. Gardner Company (Pompano Beach, Fla.). The “3M Stamark™ Liquid Pavement Marking 1500 White Part A and 1530 Crosslinker Part B” were injected into a static mix tube in the proportions of two volumes Part A to one volume Part B. The mixed binder was deposited in front of the wet film applicator that was then drawn down the roadway section parallel to the direction of traffic to complete the wet line. Immediately after drawing the wet line, elements were sprinkled uniformly on the wet binder at the rate of 0.18 oz (5 grams) per linear foot (0.3048 meters). Then 1.5 refractive index glass beads conforming to AASHTO specification M247 Type 1, commercially available from 3M Company under the trade designation “Stamark™ Liquid Pavement Marking 1250 Beads” were applied at the rate of 0.43 oz (12 grams) per linear foot (0.3048 meters) were uniformly sprinkled on the wet lines. The coated lines were then allowed to dry and cure for at least 10 minutes. The coefficient of retroreflected luminance, R_{L}, for the lines with elements and beads was then measured in accordance with ASTM E 1710.

The retained reflectivity was evaluated in three separate experimental comparisons after various durations in time. The measured coefficient of retroreflected luminance (RL) is reported in Tables 1 and 2 as follows in the units of millicandelas/m²/lux:

TABLE 1

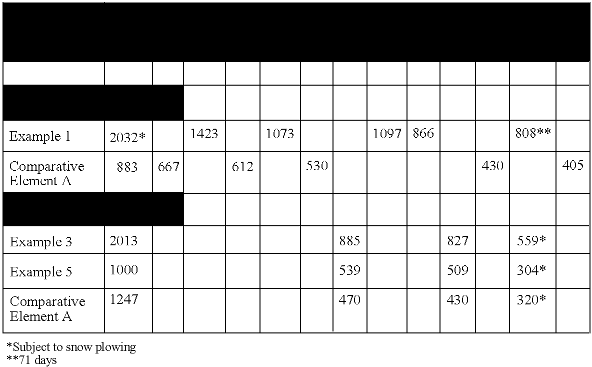

TABLE 2
3 Experimental Comparison

| Reflective | Weeks of Accelerated Testing | | | | | | | | | |
|---|---|---|---|---|---|---|---|---|---|---|
| Element | Initial | 2 | 3 | 4 | 8 | 10 | 15 | 17 | 18 | 22 |
| Example 7 | 2987 | 2247 | 2049 | | 1276 | 1317 | 1139 | 976 | | 796 |
| Example 8 | 3095 | 1923 | 1619 | | 999 | 976 | 710 | 727 | | 532 |
| Comparative A | 1300 | 857 | | 776 | | 693 | 670 | | 660 | |

The results show that the exemplified bonded resin core elements have substantially high initial coefficient of retroreflected luminance (i.e. initial brightness) than Comparative A, a commercially available ceramic core retroreflective element. The results also show that the coefficient of retroreflected luminance is at least comparable to Comparative A after 22 weeks of accelerated wear testing, which is predictive of 4.2 years of actual service life.

### Effect of Refractive Index on the Dry & Wet Coefficient of Retroreflected Luminance

Three types of bonded resin core retroreflective elements were tested to determine their retroreflective performance under dry and wet conditions.

Example 9 employed the same retroreflective elements as described in Example 7.

Example 10 employed the same retroreflective elements described in Example 7 except that 1.9 refractive index glass-ceramic beads were blended together at a weight percent of 80% with beads having a nominal refractive index of 2.37. The 2.37 refractive index microcrystalline microspheres had a starting oxide material composition by weight of 60% TiO₂, 10% ZrO₂, 10% BaO, 10% Bi₂O₃ and 10% CaO. The beads were prepared as described in Example 4 of U.S. patent application Ser. No. 10/458955 filed Jun. 11, 2003, incorporated herein by reference. The 2.37 beads were also surface treated in the same manner as the 1.9 beads, as previously described.

Example 11 employed the same retroreflective elements as described in Example 7 except that only the surface treated 2.37 refractive index glass ceramic beads were employed.

Comparative B employed 1.5 refractive index glass beads ranging in size from 0.85 mm to 1.4 mm commercially available from Potters Industries Inc. under the trade designation “Potters Visibead Plus”. Prior to use these beads were surface treated with 300 ppm Silquest A1100.

Comparative C employed 1.5 index glass beads meeting AASHTO M-247 Type I specifications, ranging in size from 0.15 mm to 0.85 mm commercially available from Swarco, Mexia, Tex. under the trade designation “AASHTO Type 1 t-20”.

### Panel Preparation Technique

Aluminum, at 0.080-inch thickness, is cut into 5 by 48 inch panels and washed with Chemfil DX 503 (manufactured by PPG) to remove oils and oxidation. This cleaning insures a better surface adhesion of the paint to the aluminum substrate. The panels are placed next a straight edge guide. Placed onto the panel and resting next to the guide is a notched paint spread square. The #25 spreader square was obtained from the Paul N. Gardner Company 316 Northeast First Street, Pompano Beach, Fla. 33060. Paint, commercially available from Diamond Vogel Paints, Orange City, Iowa under the trade designation “HD-21” is then poured into the square and then pulled along the guide. The 25-mil notch was used which gives a uniform wet thickness of 25 mils. Immediately after coating the paint elements are hand shaken on to the wet binder at a rate of 5 g/4″ width panel per ft (10 cm width per 30.5 cm) of the bonded resin core retroreflective elements and 12 g/4″ width panel per ft for Visibeads. Following application of the bonded resin core retroreflective elements, 1.5 indexed glass beads were applied at an application rate of 12 g/ft. The glass beads were obtained from Swarco out of Mexia, Tex. with the product code of AASHTO TYPE 1 t-20. Panels were allowed to dry overnight at room temperature.

The retroreflected luminance of the panels was measured under dry conditions, wet continuous conditions, as well as wet recovery conditions according to the test method previously described. The results are reported in Table 3 as follows.

TABLE 3

| Measurement | | Element Type | | | |
|---|---|---|---|---|---|
| Geometry | Example 9 | Example 10 | Example 11 | Comparative B | Comparative C |
| Dry Conditions | | | | | |
| 20 | 1688 | 552 | 253 | 346 | 220 |
| 30 | 2993 | 830 | 247 | 310 | 228 |
| 50 | 4347 | 1150 | 256 | 270 | 214 |
| 80 | 6372 | 1590 | 260 | 254 | 228 |
| Wet Continuous | | | | | |
| 20 | 23 | 103 | 129 | 41 | 14 |
| 30 | 76 | 161 | 193 | 73 | 20 |
| 50 | 21 | 159 | 212 | 43 | 11 |
| 80 | 19 | 185 | 163 | 32 | 10 |
| Wet Recovery | | | | | |
| 20 | 147 | 660 | 794 | 163 | 116 |
| 30 | 234 | 737 | 875 | 169 | 117 |
| 50 | 230 | 959 | 1128 | 175 | 83 |
| 80 | 276 | 1139 | 1292 | 176 | 131 |

The results show that bonded resin core retroreflective elements with 1.9 index glass ceramic beads (Example 9) provide a significantly higher initial coefficient of retroreflection (i.e. brightness) during dry conditions when measuring over a 20 meter to 80 meter geometry compared to retroreflective elements Comparative B and Comparative C. Bonded resin core retroreflective elements with 2.37 index beads (Example 11) provide significantly higher initial coefficient of retroreflection during wet continuous (e.g. rain) and wet recovery conditions when measuring over a 20 meter to 80 meter geometry compared to Comparative B and Comparative C. A blend of 2.37 index beaded elements and 1.9 index beads (Example 10) provide the best balance of dry and wet retroreflective performance.

### Effect of the Element Size on the Dry & Wet Brightness

In the same manner as just described for determining the effect of refractive index, panels were prepared using bonded resin core elements of different sizes. In this comparison the bonded resin core retroreflective elements as described in Examples 7 and 9, each having a size of 710-1400 um was compared to Examples 12 -15. Examples 12- 14 were made in the same manner as Example 10 whereas Example 15 was made in the same manner as Example 7 except that different size inorganic core particles were used. Examples 12 and 15 employed gravel sand, commercially available from American Material Corp. Eau Claire, Wis. under the trade designation “#10Y2” sifted through a screen to a size of 2000-3000 um. Examples 12 and 14 employed the sand, commercially available from Unimin sifted through a screen to the desired size.

The retroreflected luminance of the panels was measured under dry conditions, wet continuous conditions, as well as wet recovery conditions according to the test method previously described. The results are reported in Tables 4 and 5 as follows.

TABLE 4

| | | 80/20 Index Blended | | | |
|---|---|---|---|---|---|
| | | Elements | | | |
| | | Wet continuous | R_{L} | | |
| | Element Size | 20M | 30M | 50M | 80M |
| Example 12 | 2000-3000 um | 289 | 417 | 659 | 622 |
| Example 13 | 1000-1700 um | 65 | 74 | 162 | 133 |
| Example 9 | 710-1400 um | 103 | 161 | 159 | 185 |
| Example 14 | 500-1000 um | 100 | 61 | 149 | 137 |
| Comparative B | Visi plus | 41 | 73 | 43 | 32 |
| Comparative C | 1.5 beads | 14 | 20 | 11 | 10 |

TABLE 5

| | | 1.89 Index | | | |
|---|---|---|---|---|---|
| | | Elements | | | |
| | | Wet Continuous | R_{L} | | |
| | size | 20M | 30M | 50M | 80M |
| Example 15 | 2000-3000 um | 62 | 69 | 110 | 96 |
| Example 7 | 710-1400 um | 23 | 76 | 21 | 19 |
| Comparative B | Visi plus | 41 | 73 | 43 | 32 |
| Comparative C | 1.5 beads | 14 | 20 | 11 | 10 |

The results show that 2-3 mm glass ceramic beads having an index of 2.37 provide the highest levels of initial retroreflective brightness in a rain condition when measured over a 20 to 80 meter geometry compared to smaller elements in the size range of 0.5 mm to 1.7 mm as well as Comparative B and Comparative C.

Various modification and alterations of this invention will become apparent to those skilled in the art without departing from the scope and spirit of this invention, and it should be understood that this invention is not to be unduly limited to the illustrative embodiments set forth herein.

1. A pavement marking comprising a binder and a plurality of retroreflective elements partially embedded in the binder, wherein the retroreflective elements comprises a bonded resin core and a plurality of microcrystalline microspheres at least partially embedded in the core.

2. The pavement marking of claim 1 wherein the microspheres comprise a glass-ceramic material.

3. The pavement marking of claim 1 wherein the microspheres are non-vitreous.

4. The pavement marking of claim 1 wherein the bonded resin core comprises at least one light scattering material.

5. The pavement marking of claim 1 wherein the light scattering material is selected from the group comprising diffusely reflecting pigments, specularly reflecting pigment and combination thereof.

6. The pavement marking of claim 1 wherein the specularly reflecting pigment is a pearlescent pigment.

7. The pavement marking of claim 1 wherein the retroreflective elements have a coefficient of retroreflection of at least 10 candelas/lux/m².

8. The pavement marking of claim 1 wherein the retroreflective elements have a coefficient of retroreflection of at least 15 candelas/lux/m².

9. The pavement marking of claim 1 wherein the retroreflective elements have a coefficient of retroreflection of at least 20 candelas/lux/m².

10. The pavement marking of claim 1 wherein the marking exhibits an initial coefficient of retroreflected luminance, according to ASTM E 1710-97 of at least 2000 millicandelas/m²/lux.

11. The pavement marking of claim 1 wherein the marking exhibits a coefficient of retroreflected luminance, according to ASTM E 1710-97, of at least 400 millicandelas/m²/lux after 22 weeks of accelerated wear testing.

12. The pavement marking of claim 1 wherein a first portion of the microcrystalline microspheres have a refractive index ranging from about 1.5 to about 2.0, a second portion have a refractive index ranging from about 1.7 to about 2.6, and the difference in refractive index between the first and second portion is at least 0.2.

13. The pavement marking of claim 12 wherein the first portion has a refractive index from about 1.8 to 2.0 and the second portion has a refractive index from about 2.3 to 2.5

14. The pavement marking of claim 1 wherein the retroreflective elements range in size from about 2 mm to about 3 mm.

15. Retroreflective elements comprising a bonded resin core and a plurality of microcrystalline microspheres at least partially embedded in the core.

16. The retroreflective elements of claim 15 wherein the elements further comprise a single inorganic particle within the core.

17. The retroreflective elements of claim 16 wherein the particle ranges in size from about 0.1 mm to about 3 mm.

18. The retroreflective elements of claim 16 wherein the particle is selected from sand, roofing granules, and skid particles.

19. The retroreflective elements of claim 16 wherein the particle is surface treated with an organosilane adhesion-promoting agent.

20. The retroreflective elements of claim 15 wherein the microspheres are surface treated with an organosilane adhesion-promoting agent.

21. The retroreflective elements of claim 15 wherein the microspheres are surface treated with at least one fluorochemical floatation agent.

22. The retroreflective elements of claim 15 wherein the bonded resin prior to curing has a Brookfield viscosity at 77° F. ranging from about 1000 cps to about 10,000 cps.

23. The retroreflective elements of claim 15 wherein the bonded resin is substantially free of solvent.

24. A method for making a pavement marking comprising:
a) applying a binder composition to a pavement surface;
b) partially embedding the retroreflective elements of claim 15 in the binder; and
c) solidifying the binder.

25. The method of claim 24 wherein the binder is selected from traffic marking paint, a thermoplastic binder, and a reactive binder.

26. A pavement marking tape having a viewing surface and opposing surface comprising a binder, the retroreflective elements of claim 15 embedded on the viewing surface, and an adhesive layer disposed on the opposing surface.

27. Pavement comprising the marking of claim 1.

28. A pavement marking comprising a binder and a plurality of retroreflective elements wherein the retroreflective elements comprise a bonded resin core comprising at least 30 wt-% pearlescent pigment and a plurality of transparent microspheres at least partially embedded in the core wherein the initial coefficient of reflected luminance of the pavement marking is at least about 1000 millicandelas/lux/m² when measured according to ASTM E 1710.
